(19) United States
(12) Patent Application Publication
(10) Pub. No.: US 2008/0025312 A1
(43) Pub. Date: Jan. 31, 2008

(54) ZERO-HEADER COMPRESSION FOR IMPROVED COMMUNICATIONS

(75) Inventors: Kalyan Kuppuswamy, San Diego, CA (US); June Namgoong, Chula Vista, CA (US); Srikant Jayaraman, San Diego, CA (US); Ahmad Jalali, San Diego, CA (US); Rohit Kapoor, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/829,871

(22) Filed: Jul. 27, 2007

Related U.S. Application Data
(60) Provisional application No. 60/820,775, filed on Jul. 28, 2006.

(51) Int. Cl. H04L 12/56

(52) U.S. Cl. 370/392

(57) ABSTRACT

A communication system is disclosed in which a mobile terminal having limited power is able to communicate with a land-based network via a low-rate satellite communication link. To achieve VoIP communications via a low-rate link, link-layer assisted zero-header header compression techniques are employed to reduce VoIP packet overheads. Additionally, overheads introduced by link layer protocol layers are eliminated or reduced. A transmitting device strips RTP/UDP/IP header information from a stream of VoIP packets. The transmitting device then sends an initial context message providing the RTP/UDP/IP header information. The stripped zero-header VoIP packets are then transmitted via a satellite relay. A receiving device uses the initial context information to reconstruct the headers for the zero-header VoIP packets.

### CLAIM OF PRIORITY UNDER 35 U.S.C. §119

The present Application for Patent claims priority to Provisional Application No. 60/820,775 entitled “Satellite Based Communication”, filed Jul. 28, 2006 and assigned to the assignee hereof and hereby expressly incorporated by reference herein.

### BACKGROUND

1. Field

The present invention relates to wireless communications and, in particular, to compression and/or removal of packet headers to improve communication efficiency.

2. Background

In many regions, wireless service to mobile terminals (e.g., mobile phones, etc.) is provided by a network of land-based access points (e.g., base stations). However, some regions (such as remote areas) may not have sufficient subscribers to justify the cost of deploying a network of land-based access points. In order to provide wireless service to mobile terminals in such regions, it would be advantageous to be able to communicate through a satellite network.

In other circumstances, even when a mobile terminal may be within a wireless service region, physical obstacles (such as mountains, canyons, buildings, etc.) may prevent signals from reaching the mobile terminal. However, in many such situations, the mobile terminal still may have line-of-sight access to satellites in the sky.

In yet other instances, due to natural disasters, sabotage, and/or power outages, land-based access points may be unavailable to provide wireless service to local mobile terminals.

Mobile terminals often have a limited power supply with which to operate and communicate. While such power supply is typically adequate to communicate with land-based access points, it is inadequate (or at best marginal) to communicate with a satellite located thousands of miles away. Additionally, existing satellite communication standards are not compatible with existing wireless communication standards for mobile terminals.

Therefore, there is a need for a solution that enables mobile terminals to communicate via satellites.

### SUMMARY

A communication device is provided comprising a wireless communication interface and a processing circuit. The wireless communication interface may be configured communication with a satellite. The processing circuit may be configured to (a) obtain a stream of voice-over-IP (VoIP) packets; (b) strip an RTP/UDP/IP header from the VoIP packets to obtain zero-header VoIP packets; (c) send an initial context message with the RTP/UDP/IP header information; (d) send the zero-header VoIP packets to the satellite; and/or (e) strip Evolution-Data Optimize (EV-DO) link layer headers from the zero-header VoIP packets. The initial context message and zero-header packets may be sent via a low-rate communication link of 4.8 kilobits per seconds or less. The initial context message may include some, but not all, of the RTP/UDP/IP header information of the VoIP packets. The zero-header VoIP packets may be sent in a pre-defined frame size associated with a particular type of application.

A zero-header compression method is also provided, comprising (a) obtaining a stream of voice-over-IP packets; (b) stripping an RTP/UDP/IP header from the VoIP packets to obtain zero-header VoIP packets; (c) sending an initial context message with the RTP/UDP/IP header information; (d) stripping Evolution-Data Optimize (EV-DO) link layer headers from the zero-header VoIP packets; and/or (e) sending VoIP packets to the satellite; (f) receiving an acknowledgment of the initial context message. The initial context message and zero-header packets may be sent via a wireless interface to a satellite the initial context message and zero-header packets may be sent via a low-rate communication link of 4.8 kilobits per seconds or less. Stripping EV-DO link layer headers may include removing Quality of Service bits. The initial context message includes some, but not all, of the RTP/UDP/IP header information of the VoIP packets.

The stream of voice-over-IP packets may be received within a mobile terminal, and the initial context message is sent by the mobile terminal via a wireless interface. The stream of voice-over-IP packets may be received by a gateway from an IP-based network, and the initial context message is sent by the gateway via a wireless interface to a satellite. The zero-header VoIP packets may be sent in a pre-defined frame size associated with a particular type of application.

Consequently, a communication device is provided, comprising: (a) means for obtaining a stream of voice-over-IP packets; (b) means for stripping an RTP/UDP/IP header from the VoIP packets to obtain zero-header VoIP packets; (c) means for sending an initial context message with the RTP/JUDP/IP header information; (d) means for sending VoIP packets to the satellite; (e) means for stripping Evolution-Data Optimize (EV-DO) link layer headers from the zero-header VoIP packets; and/or (f) means for receiving an acknowledgment of the initial context message.

A processor readable medium is also provided having one or more instructions for facilitating zero-header compression in voice-over-IP communications, which when executed by a processor causes the processor to: (a) obtain a stream of voice-over-IP packets; (b) strip an RTP/UDP/IP header from the VoIP packets to obtain zero-header VoIP packets; (c) send an initial context message with the RTP/UDP/IP header information; (d) send the VoIP packets to the satellite; (e) strip Evolution-Data Optimize (EV-DO) link layer headers from the zero-header VoIP packets; and/or (f) receive an acknowledgment of the initial context message.

A processor is also provided, comprising a processing circuit configured to (a) obtain a stream of voice-over-IP (VoIP) packets; (b) strip an RTP/UDP/IP header from the VoIP packets to obtain zero-header VoIP packets; (c) send an initial context message with the RTP/UDP/IP header information; and/or (d) send the zero-header VoIP packets to the satellite.

A communication device is provided having a wireless communication interface for communicating with a satellite and processing circuit configured for zero-header decompression. The processing circuit may be configured to (a) receive an initial context message with the RTP/UDP/IP header information for a VoIP call session; (b) receiving one or more zero-header VoIP packets; (c) regenerating a VoIP packet header based on the initial context information to reconstruct the VoIP packets; (d) regenerate EVDO link layer headers for the zero-header VoIP packets; and/or (e) send an acknowledgement of the initial context message. The initial context message may include some, but not all, of the original RTP/UDP/IP header information of the VoIP packets. The zero-header VoIP packets may be received in a pre-defined frame size associated with a particular type of quality of service. The RTP/JUDP/IP header information may be further reconstructed based on information from a radio link protocol (RLP) layer.

A method for zero-header decompression is further provided, comprising: (a) receiving an initial context message with the RTP/UDP/IP header information for a VoIP call session; (b) receiving one or more zero-header VoIP packets; (c) regenerating a VoIP packet header based on the initial context information to reconstruct the VoIP packets; (d) regenerating EVDO link layer headers for the zero-header VoIP packets; and/or (e) sending an acknowledgement of the initial context message. The initial context message may include some, but not all, of the original RTP/UDP/IP header information of the VoIP packets. The zero-header VoIP packets may be received in a pre-defined frame size associated with a particular type of application. The RTP/JUDP/IP header information may be further reconstructed based on information from a radio link protocol (RLP) layer. A lower layer Real-time Transport Protocol (RTP) sequence number (SN) for a particular VoIP packet header may be reconstructed based on (A) an initial sequence number in the initial context message; and/or (B) a locally maintained sequence number that is incremented when new packets are received. An IP-ID field in the VoIP packet header is set to the RTP sequence number. A Real-time Transport Protocol (RTP) timestamp (TS) field in the VoIP packet header may be reconstructed from either based on a Real-time Transport Protocol (RTP) sequence number or a time difference between consecutive VoIP packets received.

Consequently, a communication device is provided, comprising: (a) means for receiving an initial context message with the RTP/UDP/IP header information for a VoIP call session; (b) means for receiving one or more zero-header VoIP packets; (c) means for regenerating a VoIP packet header based on the initial context information to reconstruct the VoIP packets; (d) means for regenerating EVDO link layer headers for the zero-header VoIP packets; and/or (e) means for sending an acknowledgement of the initial context message.

A processor readable medium is also provided having one or more instructions for facilitating zero-header decompression in voice-over-IP communications, which when executed by a processor causes the processor to: (a) receive an initial context message with the RTP/UDP/IP header information for a VoIP call session; (b) receive one or more zero-header VoIP packets; (c) regenerate a VoIP packet header based on the initial context information to reconstruct the VoIP packets; (d) regenerate EVDO link layer headers for the zero-header VoIP packets; and/or (e) send an acknowledgement of the initial context message.

A processor for zero-header decompression may also be provided, comprising a processing circuit configured to (a) receive an initial context message with the RTP/UDP/IP header information for a VoIP call session; (b) receive one or more zero-header VoIP packets; (c) regenerate a VoIP packet header based on the initial context information to reconstruct the VoIP packets; (d) regenerate EVDO link layer headers for the zero-header VoIP packets; and/or (e)send an acknowledgement of the initial context message.

### BRIEF DESCRIPTION OF THE DRAWINGS

FIG. 1 illustrates a wireless communication system in which a mobile terminal may use a satellite to reach a land-based wireless communication network.

FIG. 2 is a block diagram illustrating the operation of a compression module and a decompression module according to one example.

FIG. 3 illustrates an example of an initial context message for a VoIP packet that may be constructed by a compression module and sent to a decompression module.

FIG. 4 illustrates an example of how packet header information may be reconstructed by a decompression module from the initial context and other available information.

FIG. 5 illustrates an example of an acknowledge message sent by a decompression module to a compression module to acknowledge the receipt of an Initial Context message to setup context between the two modules.

FIG. 6 illustrates an example of a state machine for operation of a compression module that performs zero-header compression.

FIG. 7 illustrates an example of a state machine for operation of a decompression module that performs zero-header decompression.

FIG. 8 illustrates an EVDO 128-bit physical layer packet.

FIG. 9 is a block diagram illustrating header removal at a mobile terminal and header regeneration in a gateway on the reverse link (RL) from the mobile terminal to the gateway.

FIG. 10 is a block diagram illustrating an improved version of the system in FIG. 9 for header removal at a mobile terminal and header regeneration in a gateway on the reverse link (RL).

FIG. 11 is a block diagram illustrating a mobile terminal configured to perform zero-header compression and decompression.

FIG. 12 is a block diagram illustrating a gateway configured to perform zero-header compression and decompression.

FIG. 13 illustrates method for zero-header compression that may be operational on a mobile terminal and/or gateway to facilitate communications via a low-rate communication link via a satellite.

FIG. 14 illustrates method for zero-header compression that may be operational on a mobile terminal and/or gateway to facilitate communications via a low-rate communication link via a satellite.

### DETAILED DESCRIPTION

In the following description, specific details are given to provide a thorough understanding of the embodiments. However, it will be understood by one of ordinary skill in the art that the embodiments may be practiced without these specific details. For example, circuits may be shown in block diagrams, or not be shown at all, in order not to obscure the embodiments in unnecessary detail. In other instances, well-known circuits, structures and techniques may not be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices, and/or other machine readable mediums for storing information. The term “machine readable medium” includes, but is not limited to portable or fixed storage devices, optical storage devices, wireless channels, and various other mediums capable of storing, containing, or carrying instruction(s) and/or data.

Furthermore, embodiments may be implemented by hardware, software, firmware, middleware, microcode, or a combination thereof. When implemented in software, firmware, middleware, or microcode, the program code or code segments to perform the necessary tasks may be stored in a machine-readable medium such as a storage medium or other storage means. A processor may perform the necessary tasks. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, and the like, may be passed, forwarded, or transmitted via a suitable means including memory sharing, message passing, token passing, and network transmission, among others.

One aspect provides a link-layer assisted header compression from a mobile terminal to a network gateway to reduce the overhead being transmitted. Additionally, the overheads introduced link layer protocol layers are eliminated or reduced. The reduction in overhead reduces packet sizes and enables a mobile terminal to have sufficient power to communicate over a low-rate communication link (e.g., 2.4 Kbps RL rates) to a satellite. The service between a mobile terminal and satellite is often referred to as mobile satellite service (MSS) with ancillary terrestrial component (ATC).

In some examples described herein, a specific communication standard may be described. One such standard is known as Evolution-Data Optimize (1xEV-DO, EV-DO or EVDO) and provides fast packet establishment on both the forward and reverse links along with air interface enhancements that reduce latency and improve data rates. EVDO is a telecommunications standard for the wireless transmission of data through radio signals. It may employ multiplexing techniques such as CDMA (Code division multiple access) as well as Frequency division duplex (FDD) to maximize the amount of data transmitted.

However, the novel features described herein may also be applied to other communication standards and/or communication protocols.

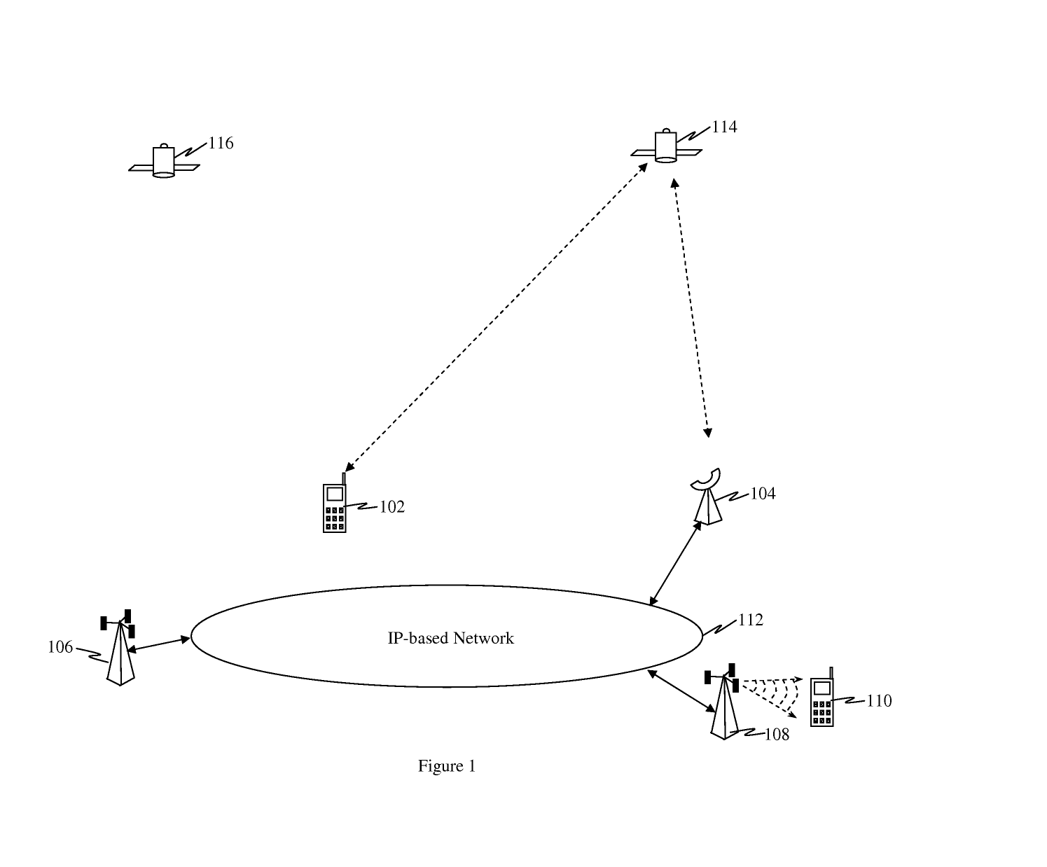

FIG. 1 illustrates a wireless communication system in which a mobile terminal may use a satellite to reach a land-based wireless communication network. The mobile terminal 102 (e.g., mobile communication device, mobile phone, wireless user terminal, etc.) may be configured to communicate with land-based access points 106 and 108 (such as base stations) that are coupled to an internet protocol (IP)-based network 112. The IP-based network 112 allows the mobile terminal 102 to communicate with other devices coupled to the network 112. For example, in one implementation, when the mobile terminal 102 is within reach of a first access point 106, it may utilize the first access point 106 to communicate with a second mobile terminal 110 via the IP-based network 112 and a second access point 108.

When the mobile terminal 102 is not within reach of an access point, it may be configured to use one or more satellites 114 and 116 to reach a gateway 104 to the IP-based network 112. For example, as illustrated, the mobile terminal 102 utilizes a first satellite 114 to reach the gateway 104 that is communicatively coupled to the IP-based network 112. In this manner, the mobile terminal 102 may reach other devices (such as the second mobile terminal 110) even when it is not within reach of an access point. In some applications, the mobile terminal 102 may be configured to utilize the satellite-based communication link as a preferred mode of operation instead of an access point.

Because of the distance from a mobile terminal to an orbiting satellite is often thousands of miles, the power available to a conventional mobile terminal may be insufficient to achieve reliable communications through a satellite. Thus, one feature provides for compressing and/or removing link layer overhead to allow of the mobile terminal to communicate over a low-rate communication link (e.g., 2.4 Kbps RL rates) to the satellite. This is particularly challenging when transmitting time-sensitive data, such as voice-over-IP (VoIP) packets where both reliability and minimum delays are important.

### Link-Layer Assisted Header Compression

One technique for reducing the overhead of packets transmitted between a mobile terminal and a satellite is to apply robust header compression to such packets.

Robust Header Compression (ROHC) offers one such techniques to reduce the large Real-time Transport Protocol (RTP)/ User Datagram Protocol (UDP)/Internet Protocol (IP) header overheads on a VoIP payload. ROHC implementation compresses the header overheads from forty (40) bytes (12 byte RTP header+ 8 byte UDP header+20 bytes for an IPv4 header) to one to two (1-2) bytes overhead. However, even this overhead is too high for the satellite application given the low-rate communication link. For example, FIG. 8 illustrates an EVDO 128-bit physical layer packet. As can be seen in FIG. 8, it is not possible to accommodate even a 1-byte ROHC header overhead to fit in a half-rate max 4 GV vocoder frame within an EVDO 128-bit physical layer packet format requirement assuming link layer overheads are not eliminated. The main reasons for the one to two (1-2) byte residual overhead after compression are: a) sequence numbers so that the receiver can rearrange out-of-sequence packets, and b) time stamps to discard packets that are received too late.

A zero-header overhead for header compression would be best. One technique to accomplish a zero-header overhead is Link-Layer Assisted (LLA) header compression for VoIP, where the gateway (e.g., access point receiving communication from satellite, Packet Data Serving Node (PDSN)) to the IP-based network act as proxy to the mobile terminal to insert the RTP/UDP/IP overhead before sending the VoIP packets over the IP-based network. Software techniques need to be designed and implemented at the handset and the gateway/PDSN to support the LLA header compression method.

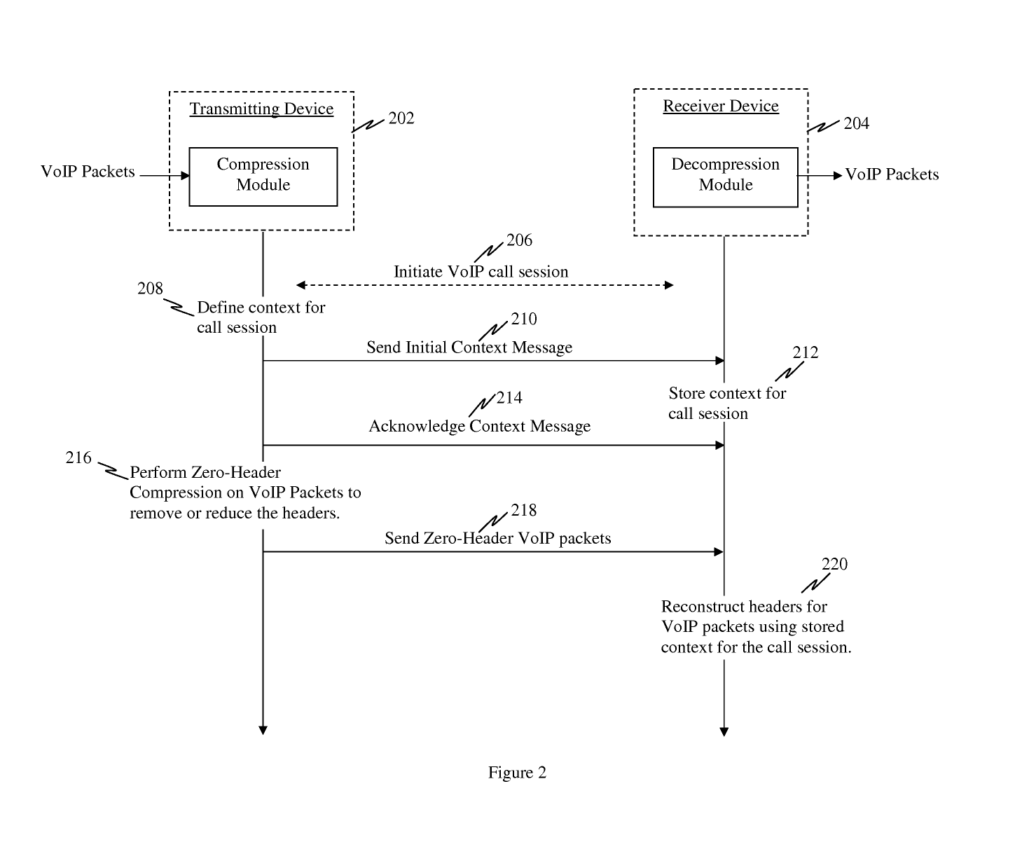

In one implementation, the LLA header compression technique may implemented by a compression module, executing in the transmit side (where the VoIP RTP/UDP/IP packets emanate), and a decompression module, executing in the receive side (where the compressed VoIP packets are received). FIG. 2 is a block diagram illustrating the operation of a compression module and a decompression module according to one example. The compression and decompression modules 202 and 204 share a set of common information for a call session (relating to VoIP RTP/UDP/IP header information) called context. At the beginning of a VoIP RTP call session 206, the compression module 202 defines a context information for the call session 208. The compression module 202 transmits the initial context information to the decompression module 204 in a signaling message 210. The decompression module 204 may store the context information 212 for use in the call session and (optionally) acknowledge receipt of the context message 214. Once the context is setup, the compression module 202 executes procedures to perform zero-header compression on the incoming VoIP packets 216 (to remove or reduce the headers) and transmits the zero-header VoIP packets 218 to the decompression module 204. The decompression module 204 reconstructs the complete RTP/UDP/IP header using the context previously provided 220 by the compression module 202, and (possibly) additional information provided by RLP layer (Link Layer-Assisted procedures).

VoIP call sessions may be established between two parties based on different call setup signaling procedures, e.g. Session Initiation Protocol (SIP) or H.323 procedures. Such signaling procedures negotiate an RTP stream to carry the actual VoIP traffic. An RTP stream for a new call setup is uniquely identified by its SSRC field in the RTP header, and further the source/destination UDP ports and source/destination IP addresses. These fields constitute the unique signature of the RTP stream. At the start of an RTP session during a VoIP call, the sender starts transmitting the RTP packets (VoIP payloads with RTP/JUDP/IP headers) and these packets are presented to the compression module 202 in the transmit side. The compression module state machine has procedures to identify that the presented RTP stream has a unique signature and initiates procedures to setup a new context for this call and send signaling information to the decompression module 204 to aid it to create a context for the new RTP session. The compression module 202 sends the complete context information regarding the new RTP stream in a signaling message (e.g., “Initial Context Info” message 210) to the decompression module 204. It may be noted that the compression module 202 may not need to send the entire RTP/UDP/IP header information in the initial context signaling packet (as is done in ROHC), but only such information from the RTP/UDP/IP header that are absolutely necessary to be conveyed to the decompression module 204 in order to aid it to recreate complete RTP/UDP/IP headers for zero-header VoIP packets. This may reduce the signaling bandwidth overhead over 50% from traditional header compression techniques such as Robust Header Compression (ROHC) and the savings are especially important when there is low rate link (e.g. 2.4 or 4.8 kbps link) between the two ends of the VoIP call. The decompression module 204 receives the new context signaling message from the compression module 202, and creates a new context for the RTP stream and saves the context information for subsequent reconstruction of RTP packets. The decompression module 204 may send an acknowledgement (ACK) signaling packet to the compression module 202 to acknowledge the receipt of a new context signaling packet. On receiving the ACK signaling packet from the decompression module 204, the compression module 202 starts stripping the RTP/UDP/IP header from the VoIP packets and transmits only the VoIP payload to the decompression module 204. The decompression module 204 reconstructs the header based on the context info and information provided by the lower layers (Physical layer/MAC layer).

### Setting-Up Context Between Compression and Decompression Modules

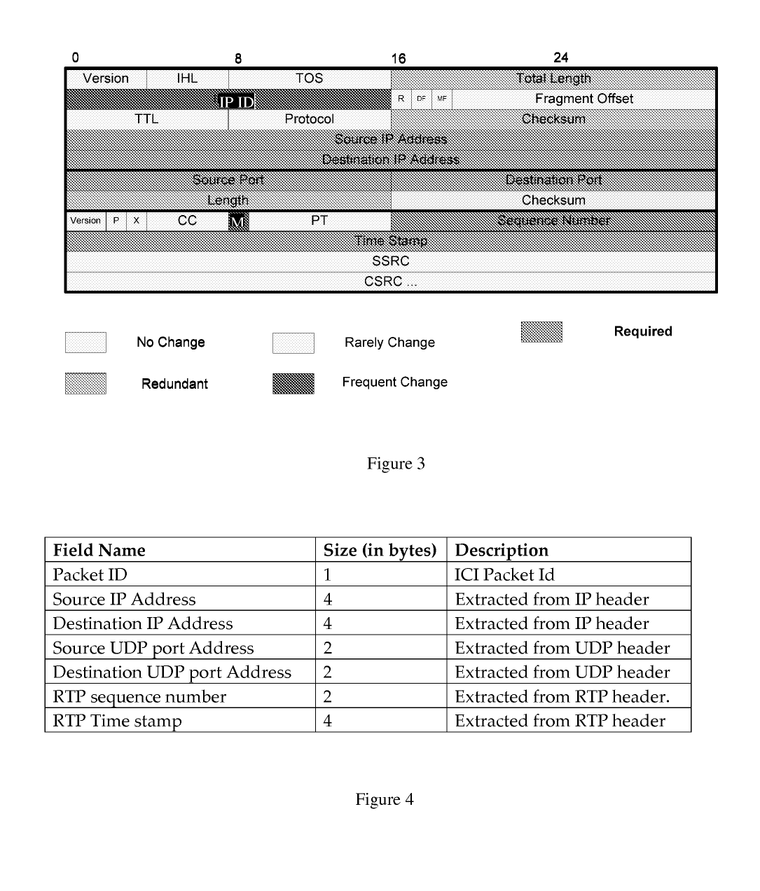

FIG. 3 illustrates an example of an initial context message for a VoIP packet that may be constructed by a compression module and sent to a decompression module. This allows the compression and decompression modules to share a set of common context information for a call session (relating to VoIP RTP/UDP/IP header information). The “Initial Context” message is constructed by the compression module and includes all such fields from the RTP/UDP/IP header for a call session. The RTP/UDP/IP header fields for a VoIP packet may be classified in the following categories: 1) Fields such as IP Version (v4) or IP Header Length (IHL) are fixed and do not change unless say the protocol revision changes to v6 or such; 2) Fields such as IP TOS (Type of Service) rarely change, and could be assumed invariant for the call duration; 3) Fields such as IP Total Length or Checksum are “redundant” in that these fields could be inferred or computed from other fields; 4) Fields such as IP ID (only for IPv4) that change frequently and may need to be computed/inferred frequently; and 5) Fields such as IP Source Address/Destination Address, etc. with dark gray color which are called “required” need to be conveyed to the other end to establish context between the compression and decompression modules. In one example, the “Initial Context” message/signaling packet transports these fields to setup a context between the compression and decompression modules.

Once the context is established between the compression and decompression modules, the compression module removes the RTP/UDP/IP headers from incoming VoIP packets to transmit a compressed zero-header VoIP packet to the decompression. Upon receiving the zero-header VoIP packet, the decompression module reconstructs the RTP/UDP/IP headers back from the shared context information and (possibly) link layer-assisted procedures described below.

### Decompression Module Processingg to Reconstruct VoIP Headers

FIG. 4 illustrates an example of how packet header information may be reconstructed by a decompression module from the initial context and other available information. The decompression module may reconstruct the VoIP header based on: a) the 18 bytes of information of the RTP/JUDP/IP header sent by the compression module during the context setup (illustrated in FIG. 4), and b) the assistance of link-layer RLP to reconstruct other header information. To completely reconstruct the RTP/UDP/IP header, the decompression module reconstructs the other header fields as follows.

RTP Sequence Number (SN) is reconstructed using link layer-assistance from the RLP layer. The decompression module increments the sequence number for every new packet (both good and error packets) received, with the initial RTP sequence number obtained from the Initial Context message sent by the compression module. The RLP layer also provides an indication when a packet is received in error. The decompression module uses the error indication to increment the RTP sequence number, but no packet is sent to the higher layer. This is done to maintain the sequence number synchronization.

IP-ID is filled with the same value as the RTP sequence number. This field is used by the IP protocol to identify the fragments of one datagram from those of another. Since the payload size of VoIP packets generated by a 4 GV half-rate max vocoder (for example) is eighty (80) bits, there is no IP fragmentation done on a VoIP packet and the IP-ID field can be set to any unique value for each packet. In particular, it can be set to the same value as the RTP sequence number reconstructed before.

RTP Time Stamp(TS) may be reconstructed using the timestamp received in the Initial Context message, sequence number of the current packet and the sequence number (SN) of the previous packet. For example, VoIP packets are generated for every twenty milliseconds (20 ms) by a 3GPP2-compliant 4 GV half-rate max vocoder. This implies the RTP timestamp increases by 160(8 K samples/sec*20 ms) for consecutive packets.

If the VoIP vocoder is also doing DTX (Discontinuous Transmission), then RTP TS may not increment in sync with RTP SN. In this case, an easy way to reconstruct the RTP TS would be to increment it by (for example) 160 every 20 msec. This does not require any reliance on RTP SN.

Type of Service (TOS) field may be filled with the value (0xb8) for Expedited Flow (EF). It is assumed that VoIP flow has characteristics of EF.

The rest of the fields are determined using the initial context information or computed from the other fields (e.g. length, checksum, etc.).

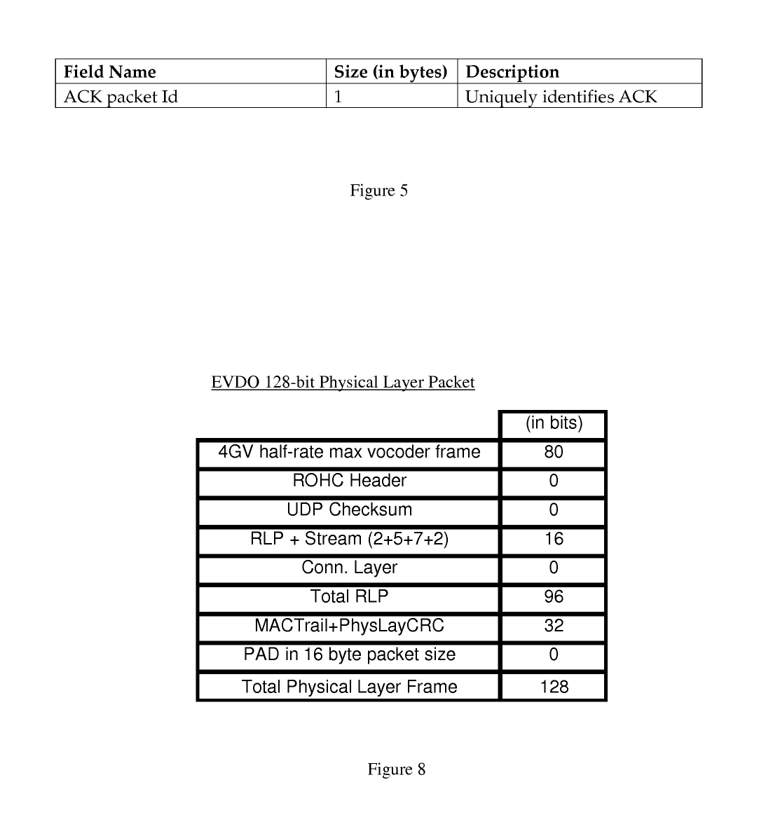

FIG. 5 illustrates an example of an acknowledge message sent by a decompression module to a compression module to acknowledge the receipt of an Initial Context message to setup context between the two modules. A single byte may be utilized to acknowledge receipt of the context information.

### State Machines for Compression and Decompression Modules

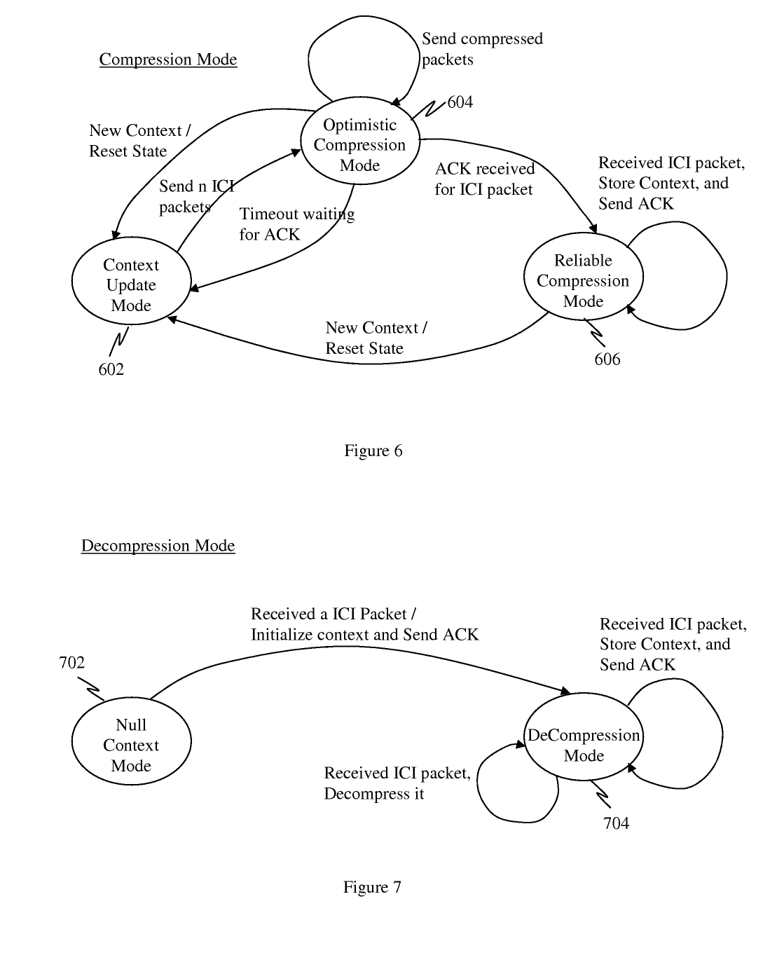

To further illustrate the operation of the compression and decompression modules in providing zero-header compression to a VoIP packet, FIGS. 6 and 7 are provided.

FIG. 6 illustrates an example of a state machine for operation of a compression module that performs zero-header compression. The initial state for the compression module is called the Context Update mode 602. In this mode, the compression module is responsible for conveying the context information to the decompression module, so that the subsequent compressed VoIP packets can be successfully decompressed at the decompression module. In the Context Update state 602, the compression module sends ‘n’ “Initial Context Info” (ICI) messages (where ‘n’ is a configurable number such as four (4) ) and transitions to the Optimistic Compression mode 604. In this state, the compression module is “optimistically” hoping that at least one (1) out of ‘n’ ICI messages would have been successfully received by the decompression module and the compression module starts executing procedures for sending zero-header compressed VoIP packets to the decompression module. Meanwhile, in this state, the compression module also waits for acknowledge (ACK) message from the decompression module as a confirmation that the decompression module has indeed received the context and both sides are operating with the same context. If the compression module receives an ACK in the Optimistic Compression mode 604, it then moves to the Reliable Compression mode 606. However in the Optimistic Compression state 604 if the compression module does not receive an ACK within a configurable timeout period, it moves back to Context Update mode 602 and starts sending ICI packets again. Once in the Reliable Compression mode 606, the compression module continues to execute procedures for sending zero-header compressed VoIP packets with the assurance that the decompression module has the full context to decompress the VoIP packets correctly. Upon a context change (e.g., a new RTP session is initiated), the compression module transitions back to the Context Update mode 602.

FIG. 7 illustrates an example of a state machine for operation of a decompression module that performs zero-header decompression. The initial state for the decompression module is called the Null Context mode 702. As soon as the decompression module receives the context message (ICI message), it initializes its context structure based on the ICI message and sends an acknowledge message (ACK) to the compression module and transitions to the decompression mode 704. In the decompression mode 704, it uses the stored context to reconstruct the complete RTP/UDP/IP header for the received compressed VoIP packet. If the decompression module receives an ICI message in this state, it sends an ACK to the compression module again since the receipt of another ICI message by the decompression module in this state indicates that the compression module has not received an ACK yet.

### Example of EVDO Link-Layer Assisted Header Removal

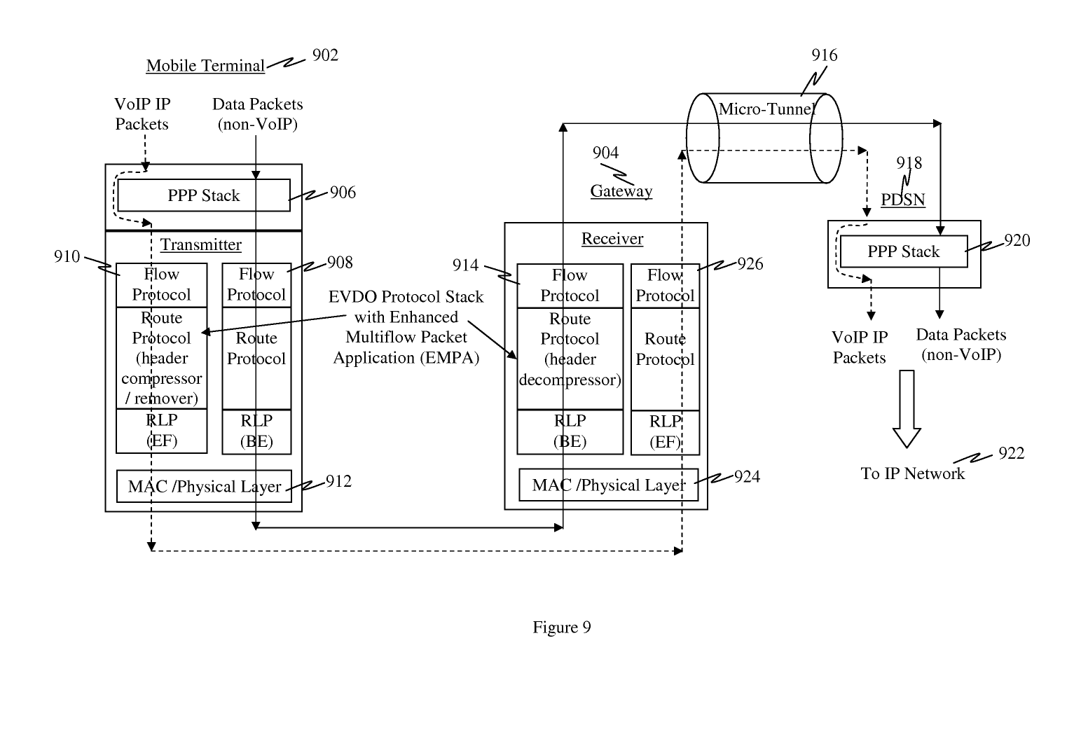

FIG. 9 is a block diagram illustrating header removal at a mobile terminal and header regeneration in a gateway on the reverse link (RL) from the mobile terminal to the gateway. The implementation on the forward link (FL) is similar. For purposes of illustration, the figure shows the paths of two flows—VoIP flow and non-VoIP data flow, which are distinct from each other. It is assumed that the mobile terminal 902 has already registered with the gateway 904 (e.g., base station), established FL/RL traffic channel, setup PPP session with the PDSN, and subsequently negotiated two flows—Expedited Flow (EF) for carrying VoIP traffic, and Best Effort (BE) flow for carrying other data traffic. It is also assumed that the necessary SIP signaling required for call setup has been executed successfully and VoIP packets are in-flight between the mobile terminal 902 and the gateway 904.

At the mobile terminal 902, the VoIP packets to be transmitted are first presented to the PPP layer from the RTP/UDP/IP layer. However, unlike other data packets, the PPP layer 906 does not frame the VoIP packets because IP packets are presented as-is, without PPP encapsulation, to the lower layers that do the header removal. The IP packet is then presented to the 1xEV-DO protocol stack 908 (data packets) and 910 (VoIP packets), where it gets through the Flow Protocol and is passed to the Route Protocol that performs the RTP/JUDP/IP header removal. For VoIP packets, the Route Protocol in the current 1xEV-DO stack 910 may include zero-header header compression procedures which completely eliminate the header overheads. Upon header removal, the VoIP packet is then passed onto the RLP layer (which is specifically configured for EF flows, viz. NAK disabled, etc.) which then adds the RLP header (sequence number, etc.) and then passes it on to the RL MAC 912 for transmission on the RL traffic channel. It is noted that the MAC layer overheads (2 bytes) and the physical layer CRC overheads are added to the VoIP packets. However, the RTP/UDP/IP headers are completely removed.

The path taken by data (non-VoIP) packets is the same as existing 1xEV-DO data packets, i.e. the IP packets are encapsulated as PPP frames, presented to the 1xEV-DO stack 908 which adds the MAC overheads, passed on to RLP flow configured for Best Effort (BE) traffic, and finally passed on to RL MAC 912 for transmission on RL traffic channel.

At the gateway 904, the received VoIP packets are demodulated and decoded and passed on to the 1xEV-DO stack 914 starting at the RLP stack for EF flow. The MAC packets are then presented to the Route Protocol that performs header insertion by regenerating the RTP/JUDP/IP headers from an initial context message from the mobile terminal 902. The current 1xEV-DO Route Protocol decompression stack regenerates these headers using link-layer assist and previously exchanged static context information received in the initial context message as discussed above. For instance, the decompression procedures may use RLP and lower layers to regenerate the RTP timestamps and RTP sequence numbers).

The header-regenerated IP packet is then passed onto the PDSN through the A10 micro-tunnel (GRE) between the gateway 904 and the Packet Data Serving Node (PDSN) 918. The PDSN 918 recognizes that VoIP packets arriving on the A10 micro-tunnel 916 for EF flow are not PPP-framed, and these IP packets (VoIP packets) bypass the PPP stack 920 on the PDSN and are routed to the external IP network 922.

The path taken by other data packets (non-VoIP packets) is conventional as per data packet path for 1xEV-DO. Namely, the RL MAC 924 protocol forwards the demodulated/decoded data packets to an EV-DO stack 926 that includes an RLP layer (with BE characterization) which then presents the packets to Route Protocol/Flow Protocol that de-capsulate the MAC headers, and forward the PPP frames on A10 tunnel 916 (GRE) between the gateway 904 and PDSN 918 meant for BE traffic. The PDSN 918 recognizes that the A10 tunnel 916 for BE traffic contains PPP-encapsulated frames, and passes these packets to the PPP stack 920, which then removes the PPP framing and puts out the IP packets to be routed to the external IP network 922.

It is noted that the Enhanced Multiflow Packet Application (EMPA) feature of 1×EV-DO air interface provides the framework for VoIP header compression and subsequent VoIP packet framing at the 1xEV-DO protocol layers (and not PPP-framed).

### Elimination of EVDO Link-Layer Headers—EMPA/QoS Bits

Besides eliminating the RTP/UDP/IP overhead for VoIP packets and reducing TCP/IP overheads for other data application packets, it is also desirable to reduce/eliminate the Radio Link Protocol (RLP) overheads introduced by 1xEV-DO link layer (e.g. link layer overheads such as RLP sequence number, among others). In fact, this reduction in RLP headers is important where small payloads of 48 bits are envisioned to be sent over 20 millisecond physical layer frames (2.4 Kbps RL rates), leaving no additional bits for link layer or upper layer overheads. Eliminating EV-DO link layer headers has significant implications since it eliminates the Enhanced Multiflow Packet Application (EMPA)/QoS bits, which are necessary to distinguish application types with different Quality of Service (QoS) requirements. Therefore, in order to avoid including additional bits for QoS, the QoS are tied to the application. At the mobile terminal, the processor schedules the different services based on the application being used. The gateway adds QoS bits to the packets received from the mobile terminal (via a satellite) before sending to the IP-network side. The QoS bits are determined based on the application. At the gateway side the forward link (FL) scheduler may determine priority based on the QoS bits received in the packets from the IP network side.

One method to regenerate the missing QoS information at the receiver provides for defining multiple physical layer packet formats (e.g. 48 bit frames over 20 msec, 192 bit frames over 80 msec, and so on), and use the 48 bit frames exclusively for VoIP traffic, and use the other frame structures for signaling/data traffic. By this technique, the receiving end can distinguish VoIP versus non-VoIP traffic, and for the non-VoIP traffic, the 1xEV-DO link layer header need not be stripped, thus preserving the multi-flow packet application/QoS distinction capabilities to distinguish QoS requirements of different flows and RLP sequence numbers for detecting missing data packets.

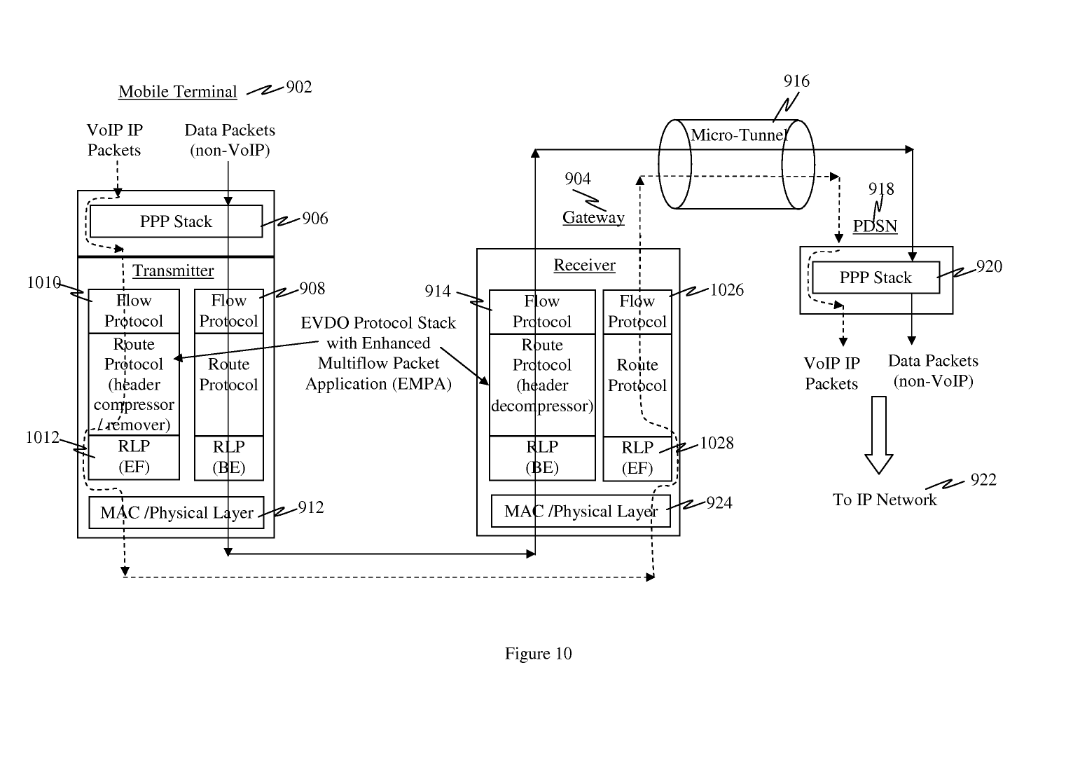

FIG. 10 is a block diagram illustrating an improved version of the system in FIG. 9 for header removal at a mobile terminal and header regeneration in a gateway on the reverse link (RL). The implementation on the forward link (FL) is similar. For purposes of illustration, the figure shows the paths of two flows—VoIP packet flow and non-VoIP data packet flow, which are distinct from each other. The data packets (non-VoIP) follow the conventional path followed by the 1xEV-DO data packets, and the path is the same illustrated and described for FIG. 9. However, for the VoIP packets, in addition to RTP/UDP/IP header removal, the 1xEV-DO MAC headers are also removed. The mobile terminal 902 includes a modified 1xEV-DO Protocol stack 1010. After the RTP/UDP/IP header is removed for the VoIP packet in the Route Protocol header compressor layer, the VoIP packet bypasses the RLP layer 1012 and is directly handed over to the RL MAC layer 912 for transmission. This bypassing of the RLP layer is an improvement over conventional 1xEV-DO systems. In one example, with a fixed 2.4 Kbps RL channel and a 2 Kbps vocoder, the VoIP packets may be exclusively transmitted over 48-bit physical layer frames (40 bits of voice samples +8 bits of CRC), and no other data/signaling packet is carried over the 48-bit physical layer packet. Instead the other physical layer frames (96-bit and 192-bit frames) are used to transport such data packets (no-VoIP packets).

At the receiving gateway, the VoIP packets are demodulated and decoded and passed onto the demultiplexing layer, which then separates packets for different RLP flows. Based on the fact that VoIP packets are uniquely carried over 48-bit physical layer frames, the demultiplexer concludes that any 48-bit physical layer packet must contain a VoIP packet, and hands over such packets to the Route Protocol layer for header insertion, thereby bypassing the RLP layer 1028. As in the transmit side, the bypassing of the RLP layer is an improvement over conventional 1xEV-DO system.

In the absence of RLP to assist the Route Protocol decompression layer in reconstructing the RLP/UDP/IP header (especially the dynamic contents like RTP timestamp and RTP sequence number), decompression is dependent on lower layers (1xEV-DO physical layer) to indicate whether it received a 48-bit physical layer packet, and if so, whether the CRC passed or failed. The Reverse Rate Indication (RRI) channel on the RL may assist in finding out the data rate being transmitted on the RL. For a fixed rate case, it is either 2.4 Kbps rate or NULL rate, i.e. no packet transmitted. This helps to identify DTX condition, i.e. silence between talkspurts.

Similarly, the physical layer also notifies the Route Protocol decompression layer if the decoded physical layer frames fail CRC. Assuming a) the physical layer passes on successfully decoded packets to the Route Protocol decompression layer, b) notifies whether decoded packets failed CRC, c) notifies the DTX condition (NULL rate RRI channel) to the Route Protocol decompression, d) VoIP frames are delivered in order over the satellite link every ‘x’ seconds (e.g., 20 msec), then the Route Protocol decompression can successfully reconstruct the dynamic context (e.g., RTP time stamp and RTP sequence number) for each successfully received VoIP packet and further regenerate the complete RTP/UDP/IP header using the static context exchanged previously. This constitutes a significant change and improvement over the conventional 1xEV-DO header decompression procedures.

As with the system described in FIG. 9, the header-regenerated IP (VoIP) packet is then passed onto the PDSN through the A10 micro-tunnel (GRE) between the RNC and the PDSN. The PDSN recognizes that VoIP packets arriving on the A10 micro-tunnel for EF flow are not PPP-framed, and these IP (VoIP) packets bypass the PPP stack on the PDSN and are routed to the external IP network.

FIG. 11 is a block diagram illustrating a mobile terminal configured to perform zero-header compression and decompression. In this example, the mobile terminal 1102 may include a processing circuit 1104 coupled to a wireless communication interface 1106 to communicate over a wireless network. The wireless communication interface 1106 may communicate with an IP-based network through either land-based access points (e.g., base stations) and/or satellites that communicate with gateways. The wireless communication interface 1006 may include a zero-header EVDO stack 1108 that is configured to compress and/or decompress VoIP packets optimized for transmission over a low-rate communication link (for instance to/from a satellite).

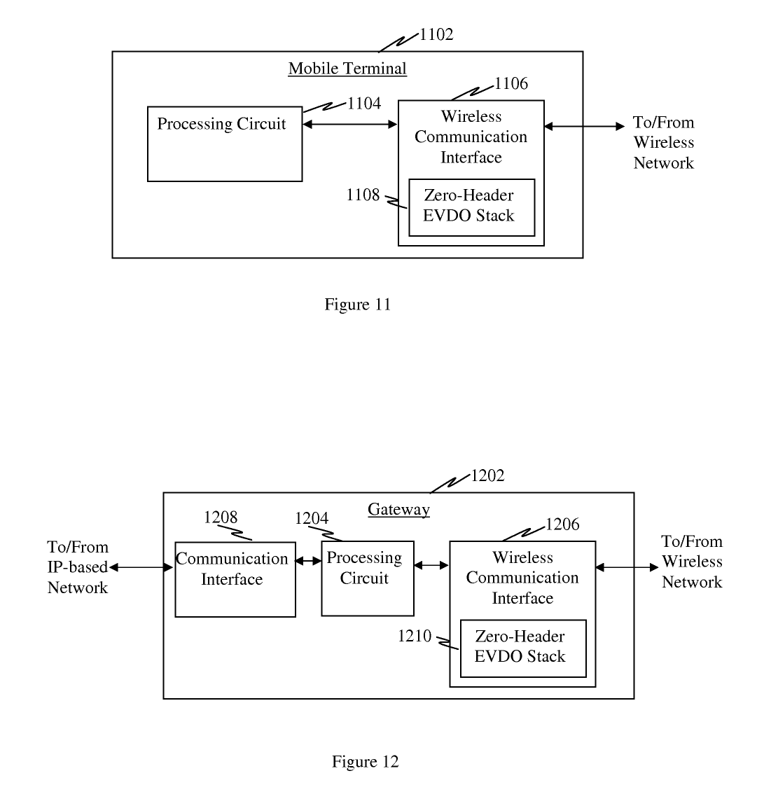

FIG. 12 is a block diagram illustrating a gateway configured to perform zero-header compression and decompression. In this example, the gateway 1202 may include a processing circuit 1204 coupled to a wireless communication interface 1206 to communicate over a wireless network and a second communication interface 1206 to communicate over an IP-based network. The wireless communication interface 1206 may communicate with a mobile terminal via a satellite relay and may include a zero-header EVDO stack 1210 that is configured to compress and/or decompress VoIP packets optimized for transmission over a low-rate communication link (for instance to/from the satellite). Consequently, the gateway 1202 may receive VoIP packets from second communication interface 1208, strip the headers to form zero-header VoIP packets, and transmit the zero-header VoIP packets over the wireless communication interface 1206. Conversely, the gateway 1202 may be receive zero-header VoIP packets from the wireless communication interface 1206, reconstruct its headers to form VoIP packets, and transmit the VoIP packets over the second communication interface 1208.

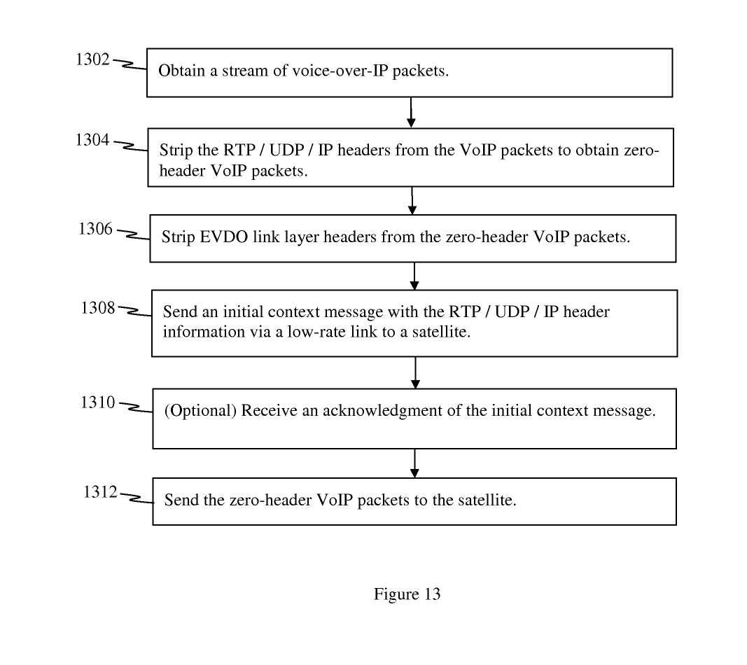

FIG. 13 illustrates method for zero-header compression that may be operational on a mobile terminal and/or gateway to facilitate communications via a low-rate communication link via a satellite. A stream of voice-over-IP packets is obtained 1302. The RTP/UDP/IP headers are stripped from the VoIP packets to obtain zero-header VoIP packets 1304. Additionally, the EVDO link layer headers may also be stripped from the zero-header VoIP packets 1306. An initial context message is sent with the RTP/UDP/IP header information via a low-rate communication link to a satellite 1308. Optionally, an acknowledgment to the initial context message may be received 1310 (indicating that the context message was received). The zero-header VoIP packets are sent (via a low-rate communication like with) to the satellite 1312.

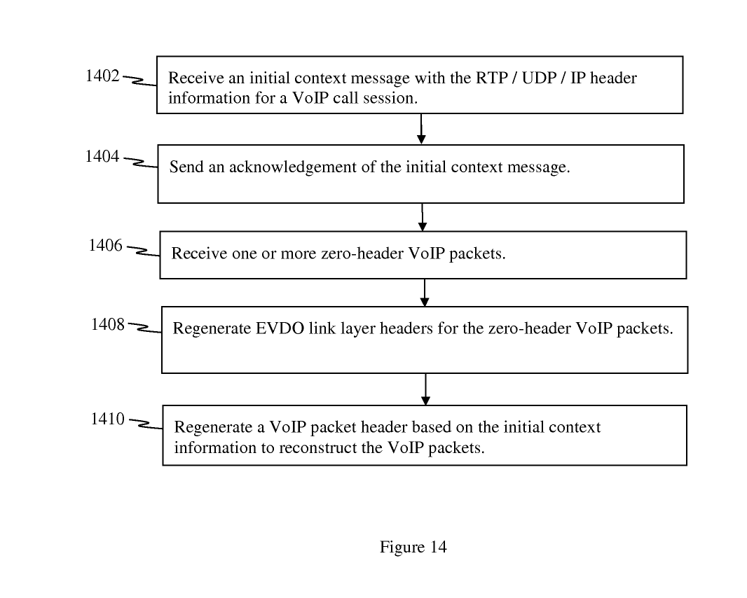

FIG. 14 illustrates method for zero-header compression that may be operational on a mobile terminal and/or gateway to facilitate communications via a low-rate communication link via a satellite. An initial context message with the RTP/UDP/IP header information for a VoIP call session is received 1402. An Acknowledgement of the initial context message may be sent as a reply 1404. One or more zero-header VoIP packets are then received 1406. EVDO link layer headers are regenerated for the zero-header VoIP packets 1408. A VoIP packet header is regenerated based on the initial context information to reconstruct the VoIP packets 1410.

One or more of the components, steps, and/or functions illustrated in FIGS. 1, 2, 3, 4, 5, 6, 7, 8, 9, 10, 11, 12, 13 and/or 14 may be rearranged and/or combined into a single component, step, or function or embodied in several components, steps, or functions without affecting the operation of the network helper for authenticating between the token and verifier. Additional elements, components, steps, and/or functions may also be added without departing from the invention. The apparatus, devices, and/or components illustrated in FIGS. 1, 9, 10, 11 and/or 12 may be configured to perform one or more of the methods, features, or steps described in FIGS. 2, 3, 4, 5, 6, 7, 8, 13 and/or 14. The novel algorithms described herein may be efficiently implemented in software and/or embedded hardware.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A communication device, comprising:
a wireless communication interface for communicating with a satellite; and
a processing circuit coupled to the wireless communication interface, the processing circuit configured to
obtain a stream of voice-over-IP (VoIP) packets;
strip an RTP/UDP/IP header from the VoIP packets to obtain zero-header VoIP packets; and
send an initial context message with the RTP/UDP/IP header information.

2. The communication device of claim 1, wherein the processing circuit is further configured to
send the zero-header VoIP packets to the satellite.

3. The communication device of claim 1, wherein the initial context message and zero-header packets are sent via a low-rate communication link of 4.8 kilobits per seconds or less.

4. The communication device of claim 1, wherein the processing circuit is further configured to:
strip Evolution-Data Optimize (EV-DO) link layer headers from the zero-header VoIP packets.

5. The communication device of claim 1, wherein the initial context message includes some, but not all, of the RTP/UDP/IP header information of the VoIP packets.

6. The communication device of claim 1, wherein the zero-header VoIP packets are sent in a pre-defined frame size associated with a particular type of application.

7. A method, comprising:
obtaining a stream of voice-over-IP packets;
stripping an RTP/UDP/IP header from the VoIP packets to obtain zero-header VoIP packets; and
sending an initial context message with the RTP/UDP/IP header information.

8. The method of claim 7, further comprising:
sending VoIP packets to the satellite.

9. The method of claim 8, wherein the initial context message and zero-header packets are sent via a wireless interface to a satellite.

10. The method of claim 8, wherein the initial context message and zero-header packets are sent via a low-rate communication link of 4.8 kilobits per seconds or less.

11. The method of claim 7, further comprising:
stripping Evolution-Data Optimize (EV-DO) link layer headers from the zero-header VoIP packets.

12. The method of claim 11, wherein the stripping EV-DO link layer headers includes removing Quality of Service bits.

13. The method of claim 7, further comprising:
receiving an acknowledgment of the initial context message.

14. The method of claim 7, wherein the initial context message includes some, but not all, of the RTP/UDP/IP header information of the VoIP packets.

15. The method of claim 7, wherein the stream of voice-over-IP packets is received within a mobile terminal, and the initial context message is sent by the mobile terminal via a wireless interface.

16. The method of claim 7, wherein the stream of voice-over-IP packets is received by a gateway from an IP-based network, and the initial context message is sent by the gateway via a wireless interface to a satellite.

17. The method of claim 7, wherein the zero-header VoIP packets are sent in a pre-defined frame size associated with a particular type of application.

18. A communication device, comprising:
means for obtaining a stream of voice-over-IP packets;
means for stripping an RTP/UDP/IP header from the VoIP packets to obtain zero-header VoIP packets; and
means for sending an initial context message with the RTP/UDP/IP header information.

19. The communication device of claim 18, further comprising:
means for sending VoIP packets to the satellite.

20. The communication device of claim 18, wherein the initial context message and zero-header packets are sent via a wireless interface to a satellite.

21. The communication device of claim 18, wherein the initial context message and zero-header packets are sent via a low-rate communication link of 4.8 kilobits per seconds or less.

22. The communication device of claim 18, further comprising:
means for stripping Evolution-Data Optimize (EV-DO) link layer headers from the zero-header VoIP packets.

23. The communication device of claim 18, further comprising:
means for receiving an acknowledgment of the initial context message.

24. The communication device of claim 18, wherein the zero-header VoIP packets are sent in a pre-defined frame size associated with a particular type of application.

25. A processor readable medium having one or more instructions for facilitating zero-header compression in voice-over-IP communications, which when executed by a processor causes the processor to:
obtain a stream of voice-over-IP packets;
strip an RTP/UDP/IP header from the VoIP packets to obtain zero-header VoIP packets; and
send an initial context message with the RTP/UDP/IP header information.

26. The processor readable medium of claim 25, further having one or more instructions which when executed by a processor causes the processor to:
send the VoIP packets to the satellite.

27. The processor readable medium of claim 25, wherein the initial context message and zero-header packets are sent via a wireless interface to a satellite.

29. The processor readable medium of claim 25, further having one or more instructions which when executed by a processor causes the processor to:
strip Evolution-Data Optimize (EV-DO) link layer headers from the zero-header VoIP packets.

30. The processor readable medium of claim 25, further having one or more instructions which when executed by a processor causes the processor to:
receive an acknowledgment of the initial context message.

31. A processor comprising:
a processing circuit configured to
obtain a stream of voice-over-IP (VoIP) packets;
strip an RTP/UDP/IP header from the VoIP packets to obtain zero-header VoIP packets; and
send an initial context message with the RTP/UDP/IP header information.

32. The processor of claim 31, wherein the processing circuit is further configured to send the zero-header VoIP packets to the satellite.

33. The processor of claim 31, wherein the zero-header VoIP packets are sent in a pre-defined frame size associated with a particular type of application.

34. A communication device, comprising:
a wireless communication interface for communicating with a satellite; and
a processing circuit coupled to the wireless communication interface, the processing circuit configured to
receive an initial context message with the RTP/UDP/IP header information for a VoIP call session;
receiving one or more zero-header VoIP packets; and
regenerating a VoIP packet header based on the initial context information to reconstruct the VoIP packets.

35. The communication device of claim 34, wherein the processing circuit is further configured to
regenerate EVDO link layer headers for the zero-header VoIP packets.

36. The communication device of claim 34, wherein the processing circuit is further configured to
send an acknowledgement of the initial context message.

37. The communication device of claim 34, wherein the initial context message includes some, but not all, of the original RTP/UDP/IP header information of the VoIP packets.

38. The communication device of claim 34, wherein the zero-header VoIP packets are received in a pre-defined frame size associated with a particular type of quality of service.

39. The communication device of claim 34, wherein the RTP/UDP/IP header information is further reconstructed based on information from a radio link protocol (RLP) layer.

40. A method, comprising:
receiving an initial context message with the RTP/UDP/IP header information for a VoIP call session;
receiving one or more zero-header VoIP packets; and
regenerating a VoIP packet header based on the initial context information to reconstruct the VoIP packets.

41. The method of claim 40, further comprising:
regenerating EVDO link layer headers for the zero-header VoIP packets.

42. The method of claim 40, further comprising:
sending an acknowledgement of the initial context message.

43. The method of claim 40, wherein the initial context message includes some, but not all, of the original RTP/UDP/IP header information of the VoIP packets.

44. The method of claim 40, wherein the zero-header VoIP packets are received in a pre-defined frame size associated with a particular type of application.

45. The method of claim 40, wherein the RTP/UDP/IP header information is further reconstructed based on information from a radio link protocol (RLP) layer.

46. The method of claim 40, wherein a lower layer Real-time Transport Protocol (RTP) sequence number (SN) for a particular VoIP packet header is reconstructed based on
an initial sequence number in the initial context message; and
a locally maintained sequence number that is incremented when new packets are received.

47. The method of claim 46, wherein an IP-ID field in the VoIP packet header is set to the RTP sequence number.

48. The method of claim 40, wherein a Real-time Transport Protocol (RTP) timestamp (TS) field in the VoIP packet header is reconstructed from either based on a Real-time Transport Protocol (RTP) sequence number or a time difference between consecutive VoIP packets received.

49. A communication device, comprising:
means for receiving an initial context message with the RTP/UDP/IP header information for a VoIP call session;
means for receiving one or more zero-header VoIP packets; and
means for regenerating a VoIP packet header based on the initial context information to reconstruct the VoIP packets.

50. The communication device of claim 49, further comprising
means for regenerating EVDO link layer headers for the zero-header VoIP packets.

51. The communication device of claim 49, further comprising
means for sending an acknowledgement of the initial context message.

52. The communication device of claim 51, wherein the initial context message includes some, but not all, of the original RTP/UDP/IP header information of the VoIP packets.

53. A processor readable medium having one or more instructions for facilitating zero-header decompression in voice-over-IP communications, which when executed by a processor causes the processor to:
receive an initial context message with the RTP/UDP/IP header information for a VoIP call session;
receive one or more zero-header VoIP packets; and
regenerate a VoIP packet header based on the initial context information to reconstruct the VoIP packets.

54. The processor readable medium of claim 53, further having one or more instructions which when executed by a processor causes the processor to:
regenerate EVDO link layer headers for the zero-header VoIP packets.

55. The processor readable medium of claim 53, further having one or more instructions which when executed by a processor causes the processor to:
send an acknowledgement of the initial context message.

56. A processor comprising:
a processing circuit configured to
receive an initial context message with the RTP/UDP/IP header information for a VoIP call session;
receive one or more zero-header VoIP packets; and
regenerate a VoIP packet header based on the initial context information to reconstruct the VoIP packets.

57. The processor of claim 56, further having one or more instructions which when executed by a processor causes the processor to:
regenerate EVDO link layer headers for the zero-header VoIP packets.

58. The processor of claim 56, further having one or more instructions which when executed by a processor causes the processor to:
send an acknowledgement of the initial context message.
